(19) United States
(12) Patent Application Publication
(10) Pub. No.: US 2002/0033756 A1
(43) Pub. Date: Mar. 21, 2002

(54) Monitoring system for electric fencing

(76) Inventors: Valery Hamm, La Fleche (FR); Yves Mulet-Marquis, La Meignanne (FR); Marc Bouilloud, Clefs (FR)

Correspondence Address: YOUNG & THOMPSON, 745 SOUTH 23RD STREET 2ND FLOOR, ARLINGTON, VA, 22202

(21) Appl. No.: 09/949,758

(22) Filed: Sep. 12, 2001

(30) Foreign Application Priority Data
Sep. 12, 2000 (FR) 00 11570

(51) Int. Cl. G08B 13/26

(52) U.S. Cl. 340/564; 340/561

(57) ABSTRACT

A communication module 13 with a microprocessor and recorded software is positioned between the user and the fencer unit of an electric fencing to ensure bi-directional transmission of information relative, on the one hand, to the status of the fencing and, on the other, to the modification of at least one operating parameter of the fencer unit.

The system relates to a monitoring system for electric fencing.

Electric fencing is generally intended to prevent animals or people from entering or leaving certain locations, particularly to keep cattle within an enclosure.

The dissuasive effect of this fencing is due to high-voltage pulses and rated electricity being transmitted along the conductor wires that constitute the fencing. It is therefore essential that the user be informed of any operating failure since animals quickly notice the absence of painful electric pulses in the fencing wires.

Devices have therefore been proposed that trigger an alarm, often an audible or visual alarm such as that in French patent 2.711 885. In the solutions known to date the alarm is emitted immediately alongside the fencer unit that generates the high-voltage pulses. These solutions are no longer entirely satisfactory because nowadays the users, who are mainly farmers, increasingly work at a distance from the location where the fencer unit and fencing are used. Short-range alarms are no longer of any use whatsoever as the farmer may be up to several kilometers away.

American patent U.S. Pat. No. 5,982,291 discloses a system for transmitting a remote alarm. This system uses a network of sensors that are distributed over the fencing and provided with radio means or a dedicated line to transmit information to a surveillance monitor which, in turn, transmits the remote alarm. In this system there is no interconnection between the fencer unit and the alarm transmitter, and the connection between the monitor and the user is unidirectional.

One aim of the present invention is to propose a monitoring system for electric fencing capable of communicating, on the one hand, with the fencer unit and, on the other, with the user who is some distance away.

A further aim of the invention is to propose a monitoring system in which communication between the fencer unit and the user is bi-directional.

The invention relates to a monitoring system for electric fencing comprising a fencing wire and a fencer unit that emits pulses to the fencing wire and that includes a device for analyzing the status of the fencing, characterized in that it comprises a communication module containing a microprocessor and recorded software to ensure automatic transmission of, on the one hand, information from the fencer unit to the user indicating the status of the fencing and, on the other, information from the user to the fencer unit relative to the modification of at least one operating parameter of the fencer unit.

According to other characteristics:

the information relative to the status of the fencing concerns either the normal operating state or the abnormal operating state;

abnormal operating results either from the electric operating of the fencing or from any unauthorized tampering with the fencer unit.

the fencer unit operating parameter is selected from the following group: pulse strength, pulse interval, ON-OFF of the local alarm, ON-OFF of the fencer unit, modification at regular intervals of the pulse strength, changeover from one power source to another;

two relays are positioned between the fencer unit and the communication module, the first to ensure transmission from the fencer unit to the module of information relative to the status of the fencing, the second to ensure transmission from the module to the fencer unit of information relative to the modification of the fencer unit operating parameters;

the communication module comprises a transmitter for dialing the phone number of the user's stationary or mobile phone;

the communication module is in a different housing from that of the fencer unit;

the communication module and fencer unit are in the same housing.

Other characteristics will be better understood from the following detailed description. The description refers to the attached figures where:

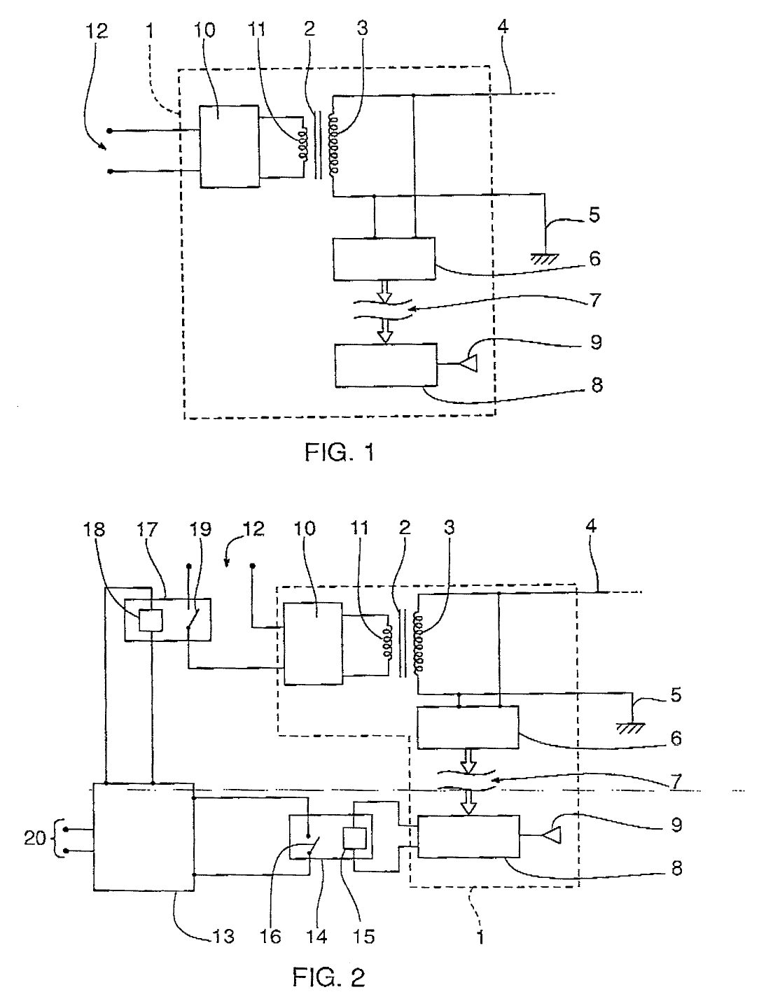

FIG. 1 shows a fencer unit for electric fencing fitted with a local alarm device of the background art;

FIG. 2 shows an embodiment of a monitoring system for electric fencing of the invention.

In FIG. 1, fencer unit 1 comprises a pulse generator 10 powered by an electrical source 12 that may be the low-voltage mains supply, an accumulator or a battery for example; a transformer 2 the primary 11 of which is powered in pulses by pulse generator 10 and the secondary 3 of which transmits high-voltage pulses (several thousands of volts) of rated electricity to fencing wire 4. Secondary 3 is connected to a ground connection 5. A device 6 is mounted in parallel with secondary 3 for analyzing the status of fencing 4 that transmits information relative to the status of the fencing to an alarm circuit 8 via an electrically insulated connection 7.

In the event of a defect, alarm circuit 8 controls, for example, a local audible alarm 9.

In FIG. 2 the same numbers refer to the same components.

According to the invention a communication module 13 is provided that contains a microprocessor and recorded software to handle communications from the fencer unit to the user and from the user to the fencer unit.

Alarm circuit 8 is connected to coil 15 of a relay 14 the contact 16 of which is connected to communication module 13. When information from analysis device 6 shows an operating fault of the electric fencing alarm circuit 8 powers coil 15 of relay 14, contact 16 closes and communication module 13 is informed of the fault. It then transmits a fault signal to the user via a transmitter and connection 20. Any type of connection 20 may be used, particularly a telephone connection or a GSM network radio connection for example, and the transmitter is capable of dialing the phone number of the user's stationary or mobile phone. The connection between alarm circuit 8 and communication module 13 can also be an electronic logic link that, in technical terms, is equivalent to relay 14.

Communication module 13 can also power coil 18 of a relay 17 the contact 19 of which powers pulse generator 10 of fencer unit 1 from electrical source 12.

When start-up or shut down information arrives from the user at communication module 13 via connection 20 module 13 controls the power supply or power cut of coil 18 and, consequently, the respective opening or closing of contact 19 and therefore the respective start-up or shutdown of fencer unit 1 in the example shown.

Relay 17 can be replaced by an electronic logic link that is technically equivalent.

According to the invention the user may be equipped with a stationary or mobile phone to receive information from communication module 13 or to transmit orders to said module to start up or shut down the fencer unit. To this effect, once users have dialed the appropriate number of the communication module they can simply press either key 1 on their telephone keypad to order the fencer unit to start up or key 0 to order it to shut down.

Furthermore, users can receive an encoded message on the screen of their stationary or mobile phone that indicates the status of the fencing, for example 1 for correct operation and 0 for abnormal operation. A fault may result from the electric operation of the fencing, for example a cut in the wire or grounding.

If the fencer unit is fitted with a security code a fault may also result from unauthorized tampering with said fencer unit.

In the example shown relative to FIG. 2 communication module 13 is positioned outside fencer unit 1 to which it is connected by a cable.

According to the invention communication module 13 can be contained in a housing independent of that of the fencer unit. It can also be contained in the housing of the fencer unit together with relays 14 and 17 or their technical equivalent.

The presence of communication module 13 ensures a bi-directional connection between the user and the fencer unit of the fencing irrespective of the distance between them. The bi-directional connection enables the user, on the one hand, to be permanently informed of the status of the fencing and to receive a voice or encoded message indicating the status and, on the other, to remotely modify one or more operating parameters of, for example, the fencer unit (this list being non-limitative):

the strength of the pulses applied to the fencing,

the interval between the successive pulses,

start up or shut down of the local audible alarm,

start up or shut down of the fencer unit,

the modification, at regular intervals, of the strength of the pulses in order to emit a higher pulse of electricity, for example, every five pulses;

changeover from one source of electricity to another, for example from a low-voltage mains supply to a battery or from one accumulator to another when the first accumulator becomes discharged.

1. A monitoring system for electric fencing comprising a fencing wire (4) and a fencer unit (1) that supplies pulses to the fencing wire (4) and includes a device (6) for analyzing the status of the fencing, characterized in that it comprises a communication module (13) containing a microprocessor and recorded software to ensure automatic transmission of, on the one hand, information from the fencer unit (1) to the user indicating the status of the fencing and on the other, information from the user to the fencer unit (1) relative to the modification of at least one operating parameter of the fencer unit (1).

2. Monitoring system of claim 1 characterized in that the information relative to the status of the fencing concerns either the normal operating status or an operating fault status.

3. Monitoring system of claim 1 characterized in that an operating fault results either from the electric operating of the fencing or from an unauthorized tampering with the fencer unit.

4. Monitoring system of claim 1 characterized in that the fencer unit operating parameter is selected from the following group: pulse strength, pulse interval, ON-OFF of the local alarm, ON-OFF of the fencer unit, modification at regular intervals of the pulse strength, changeover from one source of electricity to another.

5. Monitoring system of claim 1 characterized in that two relays are positioned between the fencer unit (1) and the communication module (13): the first (14) to ensure transmission from the fencer unit (1) to the module (13) of information relative to the status of the fencing, the second (17) to ensure transmission from the module (13) to the fencer unit (1) of information relative to the modification of the fencer unit operating parameters.

6. Monitoring system of claim 1 characterized in that the communication module (13) comprises a transmitter for dialing the phone number of the user's stationary or mobile phone.

7. Monitoring system of claim 1 characterized in that the communication module (13) is in a different housing from that of the fencer unit (1).

8. Monitoring system of claim 1 characterized in that the communication module (13) and fencer unit (1) are in the same housing.
